(19) United States
(12) Patent Application Publication
(10) Pub. No.: US 2011/0072064 A1
(43) Pub. Date: Mar. 24, 2011

(54) REDUCE INTERFERENCE FOR KVM SYSTEM

(76) Inventors: Ho-Cheng Wei, Taipei County (TW); Chien-Kuo Chan, Sijhih City (TW); Yeh Tsung I, Tainan City (TW)

(21) Appl. No.: 12/562,596

(22) Filed: Sep. 18, 2009

(51) Int. Cl. G06F 17/10

(52) U.S. Cl. 708/300

(57) ABSTRACT

Embodiments of the invention provide methods and apparatus for designing a filter configured to reduce the effects of noise in an electrical signal transferred between a KVM (Keyboard, Video, Mouse) device and another device. Designing the filter may involve determining a filter architecture, wherein the filter architecture defines a desired type of frequency response for the filter, determining one or more parameters of the filter, wherein the parameters define one or more performance characteristics of the filter, and optimizing the one or more parameters to achieve a specific desired frequency response of the filter.

### BACKGROUND OF THE INVENTION

1. Field of the Invention

The present invention generally relates to transmission of electrical signals, and more specifically to filtering of electrical signals in a Keyboard, Video, and Mouse (KVM) device.

2. Description of the Related Art

Modern organizations, be it schools, businesses, governments, or the like, rely heavily on computer systems to perform a wide variety of day to day tasks. In some cases, each person affiliated with an organization may have an assigned desktop computer, laptop computer, or the like. Each computer may communicate with a plurality of servers that store data and programming necessary to perform the day to day functions of the organization.

As the use of computer systems proliferates, modern organizations often find it difficult to find enough physical space to store all the equipment that forms the computer system. In general, the space occupied by a server is typically greater than or equal to that of a desktop or laptop computer. Furthermore, a variety of other equipment such as input and output devices must be provided to operate each of the computers and servers. Due to increasing costs for maintaining office space, most organizations find it desirable to reduce the area occupied by the computer system. Some organizations may maintain hundreds, and even thousands of servers. Accordingly, computer server management and space utilization become even more critical in such organizations.

Typically, servers are assembled on standard server racks, allowing the racks to be centrally managed and easily stacked. KVM switches may be used to effectively monitor and control the computer servers. For example, by means of a KVM switch, it is possible to manage multiple computers with only one set of keyboard, video monitor and mouse, which saves both space and cost. The KVM switches are usually mounted in the standard server rack. A KVM switch may also be integrated with a flat panel display, a keyboard, and a cursor control device. In such an integrated KVM module, usually called a LCD KVM or a KVM drawer, the KVM switch is usually stationary and the flat panel display, the keyboard and the cursor control device can be slid out from the system rack to an extend position for operation and slid back into the system rack to a closed position for storage.

### SUMMARY OF THE INVENTION

The present invention generally relates to transmission of electrical signals, and more specifically to filtering of electrical signals in a Keyboard, Video, and Mouse (KVM) device. In one embodiment, a method for designing a filter for filtering an electric signal transmitted between a Keyboard, Video, and Mouse (KVM) switch and at least one device includes determining a filter architecture, wherein the filter architecture defines a desired type of frequency response for the filter, determining one or more parameters of the filter, wherein the parameters define one or more performance characteristics of the filter, and optimizing the one or more parameters to achieve a specific desired frequency response of the filter.

In another embodiment, a computer readable storage medium comprising a program product which, when executed is configured to perform an operation for designing a filter for filtering an electric signal transmitted between a Keyboard, Video, and Mouse (KVM) switch and at least one device includes determining a filter architecture, wherein the filter architecture defines a desired type of frequency response for the filter, determining one or more parameters of the filter, wherein the parameters define one or more performance characteristics of the filter, and optimizing the one or more parameters to achieve a specific desired frequency response of the filter.

In yet another embodiment, a system includes a memory comprising a program for designing a filter for filtering an electric signal transmitted between a Keyboard, Video, and Mouse (KVM) switch and at least one device, and at least one processor which, when executing the program is configured to determine a filter architecture, wherein the filter architecture defines a desired type of frequency response for the filter, determine one or more parameters of the filter, wherein the parameters define one or more performance characteristics of the filter, and optimize the one or more parameters to achieve a specific desired frequency response of the filter.

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

### BRIEF DESCRIPTION OF THE DRAWINGS

FIG. 1 illustrates an exemplary system according to an embodiment of the invention.

FIG. 2 illustrates another exemplary system according to an embodiment of the invention.

FIG. 3 is a flow diagram of exemplary operations performed while designing a filter, according to an embodiment of the invention.

FIG. 4 illustrates yet another exemplary system according to an embodiment of the invention.

### DETAILED DESCRIPTION OF THE PREFERRED EMBODIMENTS

The present invention generally relates to transmission of electrical signals, and more specifically to filtering of electrical signals in a Keyboard, Video, and Mouse (KVM) device. Embodiments of the invention provide methods and apparatus for designing a filter configured to reduce the effects of noise in an electrical signal transferred between a KVM device and another device. Designing the filter may involve determining a filter architecture, wherein the filter architecture defines a desired type of frequency response for the filter, determining one or more parameters of the filter, wherein the parameters define one or more performance characteristics of the filter, and optimizing the one or more parameters to achieve a specific desired frequency response of the filter.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

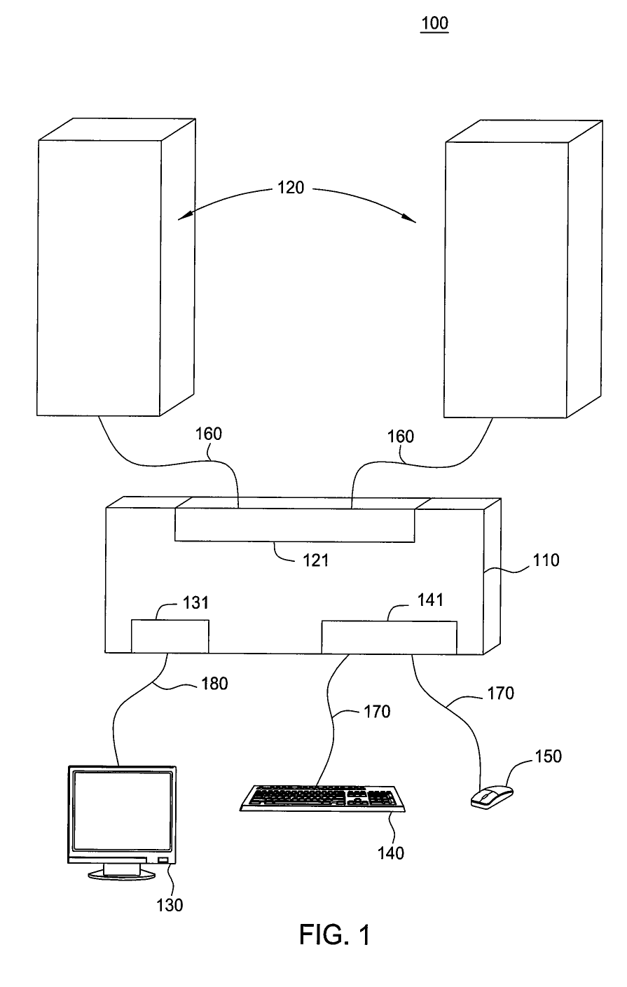

FIG. 1 illustrates an exemplary computer system 100, according to an embodiment of the invention. As illustrated in FIG. 1, the system 100 may include a switching device 110, a plurality of servers 120 (for example, two servers 120 are shown), a computer display screen 130 (hereinafter referred to simply as monitor 130), a keyboard 140, and a scrolling device 150. In one embodiment of the invention, the switching device may be a Keyboard, Video, and Mouse (KVM) switch. As illustrated in FIG. 1, the switching device 110 may be coupled with the servers 120 via an interface 121. In one embodiment of the invention, the interface 121 may be a signal converting interface.

The monitor 130 may be coupled with the switching device 110 via a video interface 131, as illustrated in FIG. 1. The video interface 131 may be configured to transfer video signals to the monitor 130. For example, in one embodiment, video signals from one of the servers 120 may be transferred to the monitor 130 by the switching device 110 via the video interface 131.

An input interface 141 may couple the keyboard 140 and the scrolling device 150, such as a mouse, to the switching device. The keyboard 140 and scrolling device 150 may be used to provide input, for example, commands to manipulate data in one of the servers 120. In one embodiment of the invention, the switching device may be configured to couple the keyboard 140, monitor 130, and the scrolling device 150 to one of the servers 120 at any given time. The user may be configured to change the specific server 120 to which the switching device is coupled by, for example, issuing one or more commands using the keyboard 140 and/or the scrolling device 150.

As illustrated in FIG. 1, a plurality of connecting cables, for example, the cables 160, 170, and 180 may coupled the servers 120, keyboard 140, scrolling device 150, and monitor 130 to the switching device 110. In one embodiment, one or more of the cables may be configured to carry video signals. For example, the cables 160 and 170 may be configured to carry video signals and other associated input and output commands to and from the switching device 110.

In a particular embodiment of the invention, the cables carrying video signals may include a Category 5 (CAT5) cable. In one embodiment the category 5 cable may include four twisted pairs in a single cable jacket. This use of balanced lines helps preserve a high signal-to-noise ratio. However, category 5 cables often suffer from interference from both external sources and other pairs, commonly referred to as crosstalk.

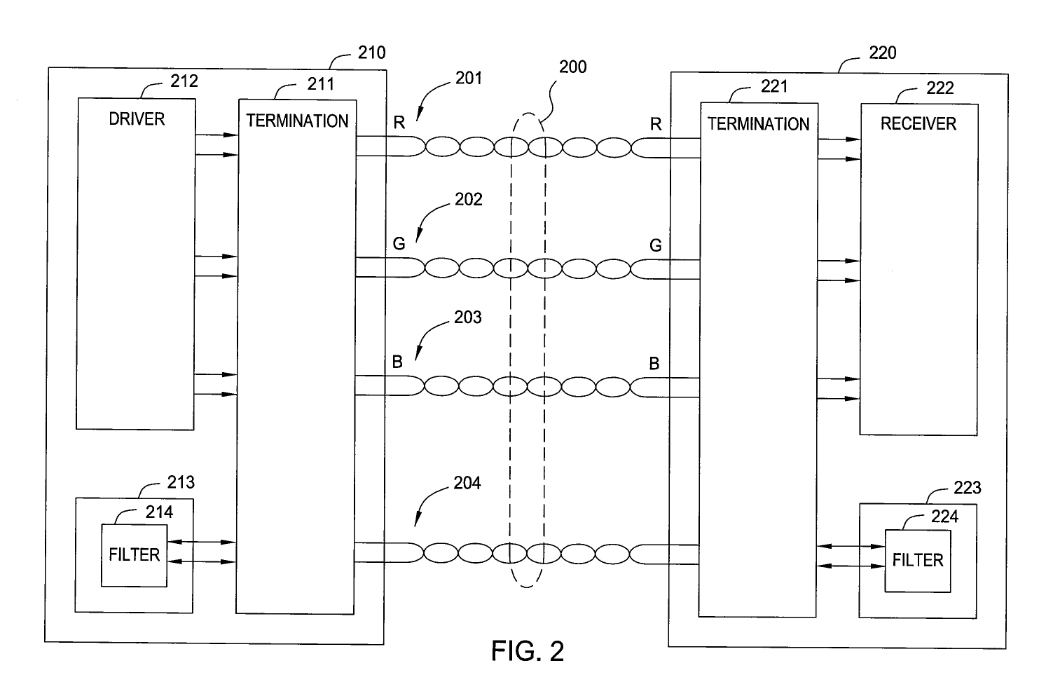

FIG. 2 illustrates a category 5 cable 200 that may be configured to transfer video signals between devices 210 and 220, according to an embodiment of the invention. In one embodiment, the devices 210 and 220 may represent at least the switching device (for example, the switching device 110 of FIG. 1) and any one of the servers 120 and the monitor 130 illustrated in FIG. 1. As illustrated in FIG. 2, the category 5 cable may include four twisted pairs 201-204. In one embodiment of the invention, the first pair 201 may be configured to carry a red video signal (R), the second pair 202 may be configured to carry a green video signal (G), and the third pair 203 may be configured to carry a blue video signal (B).

The fourth pair 204 may be configured to carry data signals. In one embodiment, the fourth pair 204 may be configured to carry one or more commands from peripheral video, keyboard and/or scrolling device connected to the system 100. Furthermore, the transmission of the data signals in the fourth pair 204 may be a bidirectional transmission transmitted between devices 210 and 220. In another embodiment, a horizontal synchronous signal (Hsync), a vertical synchronous signal (Vsync) as well as the polarity signal (of the horizontal synchronous signal and the vertical synchronous signal) may be carried on the red video signal (R), a green video signal (G), and a blue video signal (B) respectively.

As illustrated in FIG. 2, each of the devices 210 and 220 may include a respective termination device 211 and 221. The termination devices 211 and 221 may terminate each wire in the twisted pairs 201-204. In a particular embodiment of the invention, the termination devices 211 and 221 may be RJ45 connectors.

As illustrated further in FIG. 2, the termination devices 211 and 221 may be configured to couple the R, G, and B video signals from respective twisted pairs 201-203 with a driver circuit 212 of the device 210 and a receiver circuit 222 of the device 220. In other words, the twisted pairs 201-203 may be configured to transfer video signals in a single direction, i.e., from the device 210 to the device 220, in one embodiment. Accordingly, the driver circuit 212 may be configured to assert R, G, and B video signals what may be transmitted via the termination device 211, the twisted pairs 201-203, and termination device 212, to the receiver 222.

While the first to third twisted pairs 201-203 may be configured to transfer signals in a single direction, the fourth twisted pair 204 may be a bidirectional pair configured to exchange data in any direction between the devices 210 and 220. Accordingly, the twisted pair 204 is shown connected to a transmitter/receiver circuits 213 and 223, respectively, at device 210 and 220 via the termination devices 211 and 212.

As discussed above, category 5 cables may be prone to cross talk interference. The twisted pair 204 may be especially prone to cross talk interference because it is bidirectional. In other words, the unidirectional transmission of video signals on the first to third twisted pairs 201-203 may generate a relatively greater noise on the bidirectional fourth twisted pairs 204. For example, as the unidirectional transmission of video signals on the first to third twisted pairs 201-203 transmitted from the first device 210 to the second device 220, signals in the bidirectional fourth twisted pairs 204 may be concurrently transmitted from the second device 220 back to the first device. In this configuration, signals transmitted in different directions in the twisted pairs 201-204 may result in undesired higher cross talk interference.

Accordingly, in one embodiment, a filter may be provided in at least one of the devices 210 and 220 to filter out the noise in the signals transferred on the twisted pair 204. As illustrated in FIG. 2, filters 214 and 224 may be provided within the transmitter/receiver circuits 213/223, however in alternative embodiment, the filters 214/224 may be separate circuits provided at an interface between the transmitter/receiver circuits 213/223 and the termination devices 211/212.

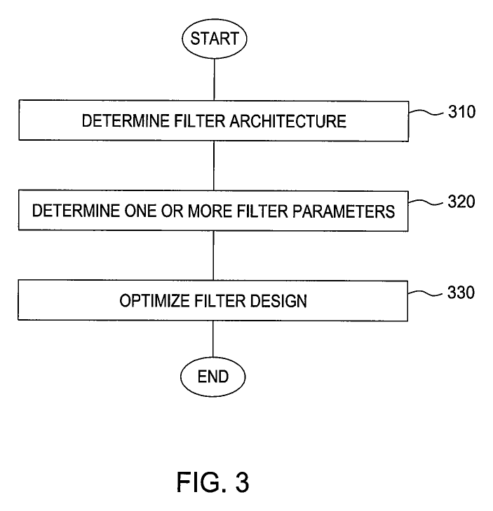

The filters 214 and 224 may be designed to effectively remove noise in signals transferred on the twisted pair 204. FIG. 3 illustrates exemplary steps that may be performed during design of a filter for the devices 210 or 220 to filter noise on the twisted pair 204. As illustrated in FIG. 3, the operations may begin in step 310 by determining a filter architecture. Exemplary filter architectures may include the Butterworth filter architecture, the Chebyshev filter architecture, Bessel Filter architecture, and the like, which are described in greater detail below.

In step 320, parameter specifications for the filters may be determined. The parameter specifications may determine one or more performance characteristics of the filters 214 and/or 224. Exemplary parameters that may be determined may include, for example, filter order, pass band, impedance, and the like. In step 330, the filter design may be optimized. Optimizing the filter design may involve adjusting one or more filter parameters to obtain a specific performance or frequency response from the filter. Exemplary optimization operations may include, for example, optimizing roll-off speed, optimizing return loss, optimizing insertion loss, and the like.

In one embodiment of the invention, the particular type of filter architecture that is used to design the filters 214 and 224 may be determined based on one or more desired operational characteristics of the filters. For example, in a particular embodiment, it may be desirable to get a maximally flat response in a pass band region of the filter. The passband refers to a range of frequencies or wavelengths that can pass through a filter without being attenuated. In such embodiments, a Butterworth type filter architecture may be utilized.

The Butterworth filter is a type of electronic filter design configured to have a frequency response which is as flat as possible in the pass band. The Butterworth filter is also commonly referred to as the maximally flat magnitude filter. The frequency response of the Butterworth filter has no ripples in the passband, and rolls off towards zero in the stopband. A stopband is a band of frequencies, between specified limits, in which a filter attenuates or does not let signals through. When viewed on a logarithmic Bode plot, the response of a Butterworth filter slopes off linearly towards negative infinity. Butterworth filters have a monotonically changing magnitude function with frequency, unlike other filter types that have non-monotonic ripple in the passband and/or the stopband.

Compared with Chebychev filters or an elliptic filter, the Butterworth filter has a slower roll-off, and thus will require a higher order to implement a particular stopband specification. However, Butterworth filter will have a more linear phase response in the passband than the Chebyshev and elliptic filters.

In some embodiments of the invention, it may be desirable to have a fast roll off speed in the stopband. In such embodiments, a Chebyshev filter may be used. Chebyshev filters can be analog or digital filters having a steeper roll-off and more passband ripple or stopband ripple than Butterworth filters.

In some embodiments of the invention, it may be desirable to have a filter having a linear phase response. In such embodiments, a Bessel type filter may be used. Bessel filters that have a maximally flat magnitude and linear phase response in the passband of the filter. While embodiments of the invention are disclosed with reference to Butterworth, Chebyshev, and Bessel filters, in alternative embodiments, any reasonable type of filter architecture, for example, elliptical filters, comb filters, or the like, may be used. The particular architecture may be selected based on a desired frequency response characteristic of the filter.

As described above with reference to FIG. 3, after selecting a desired filter architecture, one or more parameter specifications for the filter may be selected. For example, in one embodiment, an order of the filter may be determined during the filter design process. A first order filter will only have a single frequency-dependent component. Accordingly, the slope of the frequency response may be limited to 6 dB per octave. In some embodiments, to achieve steeper slopes, higher order filters may be defined.

In one embodiment of the invention determining an order of the filter may require balancing a cost of the filter with the desired performance. In general, higher order filters may perform better than lower order filters. However, higher order filters may require more components, and therefore may be much more costly to implement. Accordingly, during the filter design process, the order of the filter may be determined based on the cost of the filter and the desired performance.

The pass band may be another parameter that is defined during the filter design process. As described above, the pass band determines a range of frequencies or wavelengths that can pass through a filter without being attenuated. Frequencies that are outside the range defined by the passband may be blocked by the filter. In one embodiment of the invention, the passband may be defined based on a desired data rate for transferring signals across a twisted pair. For example, in a particular embodiment, if a maximum data rate of 5 megabits/sec (Mbps) is desired, the passband may be at least 10 MegaHertz (MHz).

Another parameter that may be defined during the filter design process is the ripple response. A ripple refers to the periodic variation in insertion loss with frequency of a filter. Not all filters exhibit ripple, some have monotonically increasing insertion loss with frequency such as the Butterworth filter. Common classes of filters which exhibit ripple are the Chebyshev filters and the Elliptical filters. The ripple is not usually strictly linearly periodic.

The amount of ripple may be traded for other parameters in the filter design. For instance, the rate of roll-off from the passband to the stopband can be increased at the expense of increasing the ripple without increasing the order of the filter (that is, the number of components has stayed the same). On the other hand, the ripple can be reduced by increasing the order of the filter while at the same time maintaining the same rate of roll-off. In a particular embodiment, the ripple response may be determined to be 0.5 dB.

Yet another parameter that may be determined is impedance seen at terminals of the filter. The impedance that is determined may include both, an input impedance and an output impedance. Input impedance may be the impedance that is seen across input terminals of the filter. The input impedance may be measured by terminating the output terminals of the filter. In contrast to the input impedance, the output impedance may be the impedance seen across output terminals of the filter. The output impedance may be measured by terminating the input terminals of the filter. In one embodiment of the invention, the output impedance seen by output terminals of the filter may be around 100 Ohms, which is typical of CAT 5 cables.

Once the filter parameters have been determined, filter design process may involve optimizing the one or more parameters to achieve one or more specific desired filter characteristics. For example, in one embodiment, if a faster roll off speed is desired, then an attenuation value of the filter may be adjusted. The higher the attenuation value, the greater may be the roll off speed at any given frequency. For example, at 15 MHz, the roll off speed at an attenuation value of −30 dB may be greater than at an attenuation value of −20 dB.

Another example of optimization may involve adjusting the return loss of the filter. Return loss or reflection loss is the reflection of signal power resulting from the insertion of a device in a transmission line or optical fiber. It is usually expressed as a ratio in dB relative to the transmitted signal power. Reflections of a signal traveling down a conductor generally occur at a discontinuity or impedance mismatch. For example, the signal reflections may occur at an interface between a CAT 5 cable and the filter input.

A large return loss may distort signals being transmitted in the passband. Accordingly, it may be desirable to reduce the return loss. In one embodiment, the return loss may be determined at a cut-off frequency. In one embodiment, an acceptable return loss may be around −20 dB.

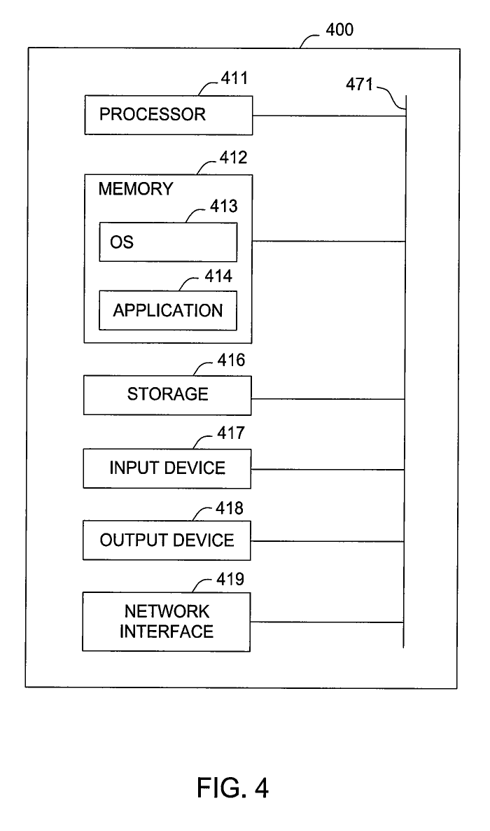

FIG. 4 depicts a block diagram of a computer system 400 according to an embodiment of the invention. In general, the computer system 400 may include a Central Processing Unit (CPU) 411 connected via a bus 471 to a memory 412, storage 416, an input device 417, an output device 418, and a network interface device 419. The input device 417 can be any device to give input to the computer system 400. For example, a keyboard, keypad, light-pen, touch-screen, track-ball, or speech recognition unit, audio/video player, and the like could be used.

The output device 418 can be any device to give output to the user, e.g., any conventional display screen. Although shown separately from the input device 417, the output device 418 and input device 417 could be combined. For example, a display screen with an integrated touch-screen, a display with an integrated keyboard, or a speech recognition unit combined with a text speech converter could be used.

The network interface device 419 may be any entry/exit device configured to allow network communications between the computer system 400 and one or more other devices via a network. For example, the network interface device 419 may be a network adapter or other network interface card (NIC).

Storage 416 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 412 and storage 416 could be part of one virtual address space spanning multiple primary and secondary storage devices.

The memory 412 is preferably a random access memory sufficiently large to hold the necessary programming and data structures of the invention. While memory 412 is shown as a single entity, it should be understood that memory 412 may in fact comprise a plurality of modules, and that memory 412 may exist at multiple levels, from high speed registers and caches to lower speed but larger DRAM chips.

Illustratively, the memory 412 contains an operating system 413. Exemplary operating systems, which may be used to advantage, include Linux (Linux is a trademark of Linus Torvalds in the US, other countries, or both) and Microsoft's Windows®. More generally, any operating system supporting the functions disclosed herein may be used.

Memory 412 may also include an application 414. Applications 414 may be software products comprising a plurality of instructions which, when executed by the CPU 411 are capable of performing operations for designing a filter, according to an embodiment of the invention. For example, the application 414 may perform, or support performance of one or more steps outlined in FIG. 2.

While the foregoing is directed to embodiments of the present invention, other and further embodiments of the invention may be devised without departing from the basic scope thereof, and the scope thereof is determined by the claims that follow.

What is claimed is:

1. A method for designing a filter for filtering an electric signal transmitted between a Keyboard, Video, and Mouse (KVM) switch and at least one device, comprising:
determining a filter architecture, wherein the filter architecture defines a desired type of frequency response for the filter;
determining one or more parameters of the filter, wherein the parameters define one or more performance characteristics of the filter; and
optimizing the one or more parameters to achieve a specific desired frequency response of the filter.

2. The method of claim 1, wherein determining the filter architecture comprises selecting one of:
a butterworth filter architecture;
a checbyshev filter architecture; and
a Bessel filter architecture.

3. The method of claim 1, wherein determining the one or more parameters comprises determining one or more of:
a filter order;
a passband of the filter;
a ripple response of the filter; and
an impedance at one or more ports of the filter.

4. The method of claim 1, wherein optimizing the one or more parameters comprises selecting an attenuation value for a predefined frequency, wherein the attenuation value determines a roll off speed of the filter.

5. The method of claim 1, wherein optimizing the one or more parameters comprises adjusting a return loss of the filter, wherein the return loss determines a distortion level in the electric signal.

6. The method of claim 5, wherein the return loss is adjusted to −20 dB.

7. A computer readable storage medium comprising a program product which, when executed is configured to perform an operation for designing a filter for filtering an electric signal transmitted between a Keyboard, Video, and Mouse (KVM) switch and at least one device, comprising:
determining a filter architecture, wherein the filter architecture defines a desired type of frequency response for the filter;
determining one or more parameters of the filter, wherein the parameters define one or more performance characteristics of the filter; and
optimizing the one or more parameters to achieve a specific desired frequency response of the filter.

8. The storage medium of claim 7, wherein determining the filter architecture comprises selecting one of:
a butterworth filter architecture;
a checbyshev filter architecture; and
a Bessel filter architecture.

9. The storage medium of claim 7, wherein determining the one or more parameters comprises determining one or more of:
a filter order;
a passband of the filter;
a ripple response of the filter; and
an impedance at one or more ports of the filter.

10. The storage medium of claim 7, wherein optimizing the one or more parameters comprises selecting an attenuation value for a predefined frequency, wherein the attenuation value determines a roll off speed of the filter.

11. The storage medium of claim 7, wherein optimizing the one or more parameters comprises adjusting a return loss of the filter, wherein the return loss determines a distortion level in the electric signal.

12. The storage medium of claim 11, wherein the return loss is adjusted to −20 dB.

13. A system comprising:
a memory comprising a program for designing a filter for filtering an electric signal transmitted between a Keyboard, Video, and Mouse (KVM) switch and at least one device; and
at least one processor which, when executing the program is configured to:
determine a filter architecture, wherein the filter architecture defines a desired type of frequency response for the filter;
determine one or more parameters of the filter, wherein the parameters define one or more performance characteristics of the filter; and
optimize the one or more parameters to achieve a specific desired frequency response of the filter.

14. The system of claim 13, wherein the processor is configured to determine the filter architecture by selecting one of:
a butterworth filter architecture;
a checbyshev filter architecture; and
a Bessel filter architecture.

15. The system of claim 13, wherein the processor is configured to determine the one or more parameters by determining one or more of:
a filter order;
a passband of the filter;
a ripple response of the filter; and
an impedance at one or more ports of the filter.

16. The system of claim 13, wherein the processor is configured to optimize the one or more parameters by selecting an attenuation value for a predefined frequency, wherein the attenuation value determines a roll off speed of the filter.

17. The system of claim 13, wherein the processor is configured to optimize the one or more parameters by adjusting a return loss of the filter, wherein the return loss determines a distortion level in the electric signal.

18. The system of claim 17, wherein the return loss is adjusted to −20 dB.
